(19) United States
(12) Patent Application Publication
(10) Pub. No.: US 2008/0259802 A1
(43) Pub. Date: Oct. 23, 2008

(54) Frequency domain packet scheduling under fractional load

(75) Inventors: Klaus Pedersen, Aalborg (DK); Preben Mogensen, Gistrup (DK); Guillaume Monghal, Aalborg (DK); Akhilesh Pokhariyal, London (GB)

Correspondence Address: HARRINGTON & SMITH, PC, 4 RESEARCH DRIVE, SHELTON, CT, 06484-6212, US

(73) Assignee: Nokia Corporation

(21) Appl. No.: 12/148,337

(22) Filed: Apr. 18, 2008

Related U.S. Application Data
(60) Provisional application No. 60/925,511, filed on Apr. 19, 2007.

(51) Int. Cl. H04L 12/56

(52) U.S. Cl. 370/235

(57) ABSTRACT

Methods, apparatus and computer program products implement frequency domain packet scheduling in a fractional load situation by detecting a fractional load situation in a wireless communications network; receiving information indicative of signal conditions in a cell; using the information indicative of signal conditions in the cell to determine physical resource blocks in use in a nearby cell; determining how many physical resource blocks are need to perform packet transmission operations in dependence on packet traffic in the cell; selecting particular physical resource blocks to be used to perform initial packet transmission operations in the cell downlink so as to avoid those physical resource blocks in use in the nearby cell; and when selecting physical resource blocks to perform future packet transmission operations in the cell downlink, favoring those physical resource blocks used to perform initial packet transmission operations.

### CROSS REFERENCE TO A RELATED UNITED STATES PATENT APPLICATION

This application hereby claims priority under 35 U.S.C. § 119(e) from copending provisional U.S. Patent Application No. 60/925,511 entitled “FREQUENCY DOMAIN PACKET SCHEDULING UNDER FRACTIONAL LOAD” filed on Apr. 19, 2007 by Klaus Pedersen, Preben Mogensen, Guillaume Monghal and Akhilesh Pokhariyal. This preceding provisional application is hereby incorporated by reference in its entirety as if fully restated herein.

### TECHNICAL FIELD

The present invention generally concerns packet scheduling in wireless communications networks, and more particularly concerns packet scheduling in fractional-load situations to reduce inter-cell interference.

### BACKGROUND

The following abbreviations are herewith defined:

### 3.9G 3GPP Long Term Evolution

### 3GPP 3^{rd} Generation Partnership Project

### CQI/CMR Channel Quality Indicator (LTE)/Channel Measurement Report (WiMax)

DL downlink
FL fractional load
FDMA frequency division multiple access
FDPS frequency-domain packet scheduling

### LTE 3GPP Long Term Evolution

OFDMA orthogonal frequency division multiple access
PRB physical resource block (for LTE)
PS packet scheduler
SFN single frequency network
SINR signal to interference-plus-noise ratio
UE user equipment

As OFDMA can provide intra-cell orthogonality by means of a cyclic prefix, the main source of interference in downlink is inter-cell interference (ICI). (See A. Pohariyal, G. Monghai, K. I. Pedersen, P. E. Mogensen, I. Z. Kovacs, C. Rosa and T. E. Kolding, “Frequency Domain Packet Scheduling Under Fractional Load for the UTRAN LTE Downlink”, accepted for publication in the IEEE Vehicular Technology Conference (VTC), Dublin, Ireland, April 2007). It can severely limit the throughput of users near the cell edge in a reuse 1 network with continuous coverage. When the network is experiencing a lack of traffic, the frequency-domain packet scheduler optimizes resource allocation by transmitting only on a portion of the system bandwidth, i.e., a subset of the available physical resource blocks (PRB), in each cell. This leads to a reduction in inter-cell interference and thereby an improvement in SINR, which can be particularly useful to cell-edge users as their data-rate can be improved.

However, under Fractional Load (FL) the setting of a proper PRB transmission pattern in each cell is non-trivial operation. The following methods have been proposed.

A first method operates in a synchronized manner. The PRB transmission pattern in each cell is selected to ensure that the interfering cells emit power on non-overlapping PRBs/frequencies, achieved by means of inter-cell signaling. The additional signaling overhead can be large due to the requirement of fast adaptations, e.g., on the order of tens of milliseconds. Further, the need for centralized control has to be justified with significant performance improvement.

A second method operates in a non-centralized manner. The PRB transmission pattern is decided within each cell by utilizing only the information which is available internally, e.g., using a smart scheduler such as FDPS. (See A. Pokhariyal, T. E. Kolding and P. E. Mogensen, “Performance of Downlink Frequency Domain Packet Scheduling for the UTRAN Long Term Evolution”, Proceedings of the IEEE Personal Indoor and Mobile Radio Communications Conference (PIMRC), pp. 1-5, Helsinki, Finland, September 2006). This technique is more general and can adapt rapidly to the fluctuations in traffic as well as in radio propagation. Further, no centralized control is required.

### SUMMARY OF THE INVENTION

An embodiment of the invention is an apparatus comprising a scheduler, the scheduler configured to perform scheduling of packets to be transmitted in a downlink of a cell of a wireless communications network during a fractional load period, the scheduler further configured to determine a size of a set of channel components to be used to transmit the packets in the downlink in dependence on packet traffic conditions; and to select particular channel components to comprise the set of channel components in such a way so as to favor channel components that have been recently used to perform packet transmission.

Another embodiment of the invention is a method comprising: using packet scheduling to assign packets to channel components in a downlink of a cell of a wireless communications system; detecting a fractional load situation; determining how many channel components are needed to perform packet transmission operations in dependence on packet traffic in the cell; selecting particular channel components to be used to perform initial packet transmission operations; and when selecting channel components to perform future packet transmission operations in the cell downlink, selecting first those channel components used to perform initial packet transmission operations.

A further embodiment of the invention is a method comprising: using packet scheduling in a fractional load situation to assign packets to channel components in a cell downlink of a wireless communications system; determining how many channel components are needed to perform packet transmission operations in the cell downlink in dependence on packet traffic; and selecting particular channel components to be used to perform packet transmission operations so as to avoid channel components in use in at least one nearby cell.

Yet another embodiment of the invention is a apparatus comprising: a scheduler means for performing scheduling of packets to be transmitted in a downlink of a cell of a wireless communications system during a fractional load period; for detecting the fractional load period; for determining a size of a set of channel components to be used for transmitting the packets in dependence on packet traffic conditions; and for selecting channel components to comprise the set of channel components in such a way so as to favor channel components that have been recently used to perform packet transmission.

A still further embodiment of the invention is base station comprising: a transceiver configured for bidirectional communications in a wireless telecommunications network; and a base station control apparatus, the base station control apparatus comprising a scheduler and a transmission power controller. The scheduler is configured to perform scheduling of packets to be transmitted in a downlink of a cell of the wireless communications network; to determine a size of a set of physical resource blocks to be used to transmit the packets in dependence on packet traffic conditions; and to select particular physical resource blocks to comprise the set of physical resource blocks in such a way so as to favor physical resource blocks that have been recently used to perform packet transmission. The transmission power controller is configured to operate the transceiver so as to transmit the physical resource blocks containing the packets at a substantially constant power level across the physical resource blocks.

An embodiment of the invention is a base station comprising: transceiver means for performing bidirectional communications in a wireless telecommunications network; and a base station control means for controlling operation of the base station, the base station control means further comprising: a scheduling means and a transmission power control means. The scheduling means is for performing scheduling of packets to be transmitted in a downlink of a cell of an orthogonal frequency division multiple access wireless communications system using frequency division packet scheduling; for detecting a fractional load situation; for determining a size of a set of physical resource blocks to be used for transmitting the packets in dependence on packet traffic conditions; and for selecting particular physical resource blocks to comprise the set of physical resource blocks in such a way so as to favor physical resource blocks that have been recently used to perform packet transmission. The transmission power control means is for operating the transceiver means so as to transmit the physical resource blocks containing the packets at a substantially constant power level across the physical resource blocks.

Another embodiment of the invention is a computer program product comprising a computer readable memory medium tangibly embodying a computer program executable by a digital processor, wherein when the computer program is executed by the digital processor, the computer program is configured to cause an apparatus operative in a wireless communications system to perform packet scheduling in a fractional load situation by assigning packets to channel components in a downlink of the wireless communications system in such a way so as to reduce inter-cell interference; to determine a size of a set of channel components needed to perform packet transmission operations in the cell downlink in dependence on cell traffic; and to select particular channel components to be used to perform packet transmission operations so as to avoid channel components in use in at least one nearby cell.

A further embodiment of the invention is a computer program product comprising a computer readable memory medium storing a computer readable program executable by a digital processor, wherein when executed by the digital processor the computer program is configured to operate apparatus to perform packet scheduling by assigning packets to channel components in a downlink of the wireless communications system; to detect a fractional load situation; to receive information indicative of signal conditions in the cell; to use the information indicative of signal conditions in the cell to determine channel components likely to be in use in a nearby cell; to determine how many channel components are needed to perform packet transmission operations in dependence on packet traffic in the cell; and to select particular channel components to be used to perform initial packet transmission operations in the cell downlink so as to avoid those channel components likely to be in use in the nearby cell.

In conclusion, the foregoing summary of the various embodiments of the present invention is exemplary and non-limiting. For example, one or ordinary skill in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram depicting a communications system in which the invention may be practiced;

FIG. 2 depicts a situation where user equipment encounters inter-cell interference in a cellular wireless communications system;

FIG. 3 is a chart depicting aspects of the invention;

FIG. 4 is a block diagram depicting base station configured in accordance with the invention;

FIG. 5 is a flowchart depicting a method operating in accordance with the invention; and

FIG. 6 is a flowchart depicting another method operating in accordance with the invention.

### DETAILED DESCRIPTION OF THE PREFERRED EMBODIMENTS

An aspect of the invention concerns vendor-specific eNode-B packet scheduling algorithms for use in a downlink operating in LTE FDD mode that is attractive for fractional load scenarios. Methods and apparatus operating in accordance with the invention use improved frequency-domain packet scheduling (FDPS) techniques to reduce the impact of inter-cell interference experienced in the downlink of an orthogonal frequency division multiple access (OFDMA) based cellular system. Method and apparatus operating in accordance with the invention utilize the lack of traffic in the network, i.e., the fractional load (FL) scenario, to improve the experienced SINR through the use of a channel aware scheduler. The method and apparatus of the invention do not rely on any centralized administration, e.g., frequency planning. The methods and apparatus of the invention can be applied to any modern cellular system based on OFDMA radio access, which supports fast channel-aware link adaptation and packet scheduling, e.g., 3GPP long term evolution (LTE).

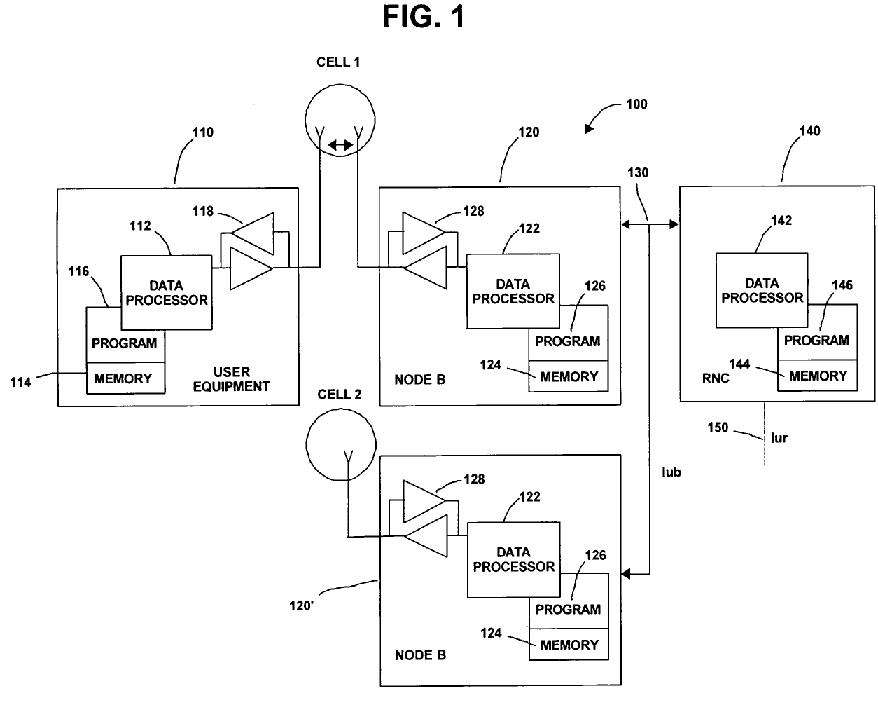

Before proceeding with a description of the invention, a suitable technical environment in which the methods and apparatus of the invention can be practiced will be described. Reference is made first to FIG. 1 for illustrating a simplified block diagram of various electronic devices that comprise the suitable technical environment. In FIG. 1 a wireless network 100 is adapted for communication with a UE 110 via a Node B (base station) 120. The network 100 may include a radio network controller (RNC) 140, or other radio controller function, which may be referred to as a serving RNC (SRNC). The UE 110 includes a data processor (DP) 112, a memory (MEM) 114 that stores a program (PROG) 116, and a suitable radio frequency (RF) transceiver 118 for bidirectional wireless communications with the Node B 120, which also includes a DP 122, a MEM 124 that stores a PROG 126, and a suitable RF transceiver 128. The Node B 120 is coupled via data path 130 (IUB) to the RNC that also includes a DP 142 and a MEM 144 storing an associated PROG 146. The RNC may be coupled to another RNC (not shown) by another data path (IUR). At least one of the PROGs 116, 126 and 146 is assumed to include program instructions that, when executed by the associated DP, enable the electronic device to operate in accordance with the exemplary embodiments of this invention, as will be discussed below in greater detail.

Shown in FIG. 1 is also a second Node B 120′, it being assumed that the first Node B establishes a first cell (Cell 1) and the second Node B establishes a second cell (Cell 2). In FIG. 1 Cell 1 is assumed to be the cell in which the packet transmission operations subject to inter-cell interference are occurring. Cell 2 represents a nearby cell that may be spatially separated (as shown), adjacent or overlapping, and other cells will typically be present as well.

The exemplary embodiments of this invention may be implemented by computer software executable by the DP 112 of the BS 120 and the other DPs, such as in cooperation with a DP in the network, or by hardware, or by a combination of software and/or firmware and hardware.

In general, the various embodiments of the UE 110 can include, but are not limited to, cellular telephones, personal digital assistants (PDAs) having wireless communication capabilities, image capture devices such as digital cameras having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 114, 124 and 144 may be of any type suitable to the local technical environment and may be implemented using any suitable data storage technology, such as semiconductor-based memory devices, magnetic memory devices and systems, optical memory devices and systems, fixed memory and removable memory. The DPs 112, 122 and 142 may be of any type suitable to the local technical environment, and may include one or more of general purpose computers, special purpose computers, microprocessors, digital signal processors (DSPs) and processors based on a multi-core processor architecture, as non-limiting examples.

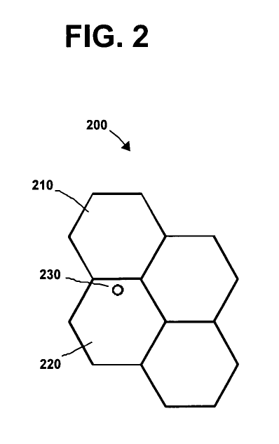

The cells 1 and 2 operate at least in the downlink according to an orthogonal frequency division multiple access system. Physical resource blocks used to perform transmission operations in the cells are reused. Accordingly, as depicted in FIG. 2, a user equipment 230 operating at an edge of cell 220 may experience significant inter-cell interference caused by transmissions emanating from cell 210.

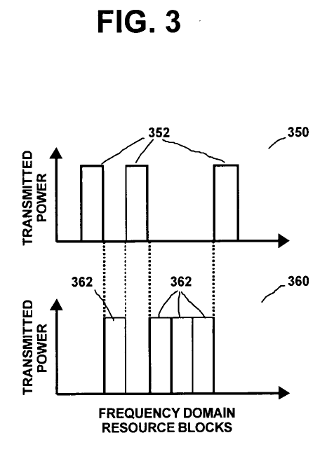

In such a situation, methods and apparatus operating in accordance with the invention use information internal to cell 220 to perform frequency domain packet scheduling so as to avoid physical resource blocks in use in nearby or adjacent cells such as cell 210. This aspect is depicted in FIG. 3. As shown, physical resource blocks 362 selected for packet transmission in the downlink of cell 220 do not coincide with physical resource blocks 352 in use in cell 210. In further aspects of the invention, additional improvements are made to the frequency division packet scheduling operations.

Another aspect of the invention is depicted in FIG. 3 where the transmit power is kept constant for active PRBs. The number of active PRBs is selected in dependence on packet traffic load, i.e., for a low amount of packet traffic there will only be transmission of a few number of PRBs per cell.

A further aspect of the invention comprises increasing the time correlation between physical resource blocks used to perform earlier packet transmission operations and later packet transmission operations in the cell downlink. The correlation is increased by favoring particular physical resource blocks used to perform earlier packet transmission operations when selecting physical resource blocks to perform later packet transmission operations. In one embodiment of the invention this is accomplished by setting a minimum duration during which the activity state of a PRB cannot be changed. In other words, the algorithm introduces time-correlation in the PRB usage pattern. The coherence time of the PRB usage pattern is set such that it is larger than the link adaptation delay.

Methods and apparatus of the invention select the number of PRBs allowed for transmission essentially depending on the cell traffic. The introduction of time-correlation in the PRB usage pattern is required to enable the tracking of inter-cell interference variations on the basis of the received channel quality indicator (CQI) reports. (Reference in this regard can be had to 3GPP TS 36.213, “Evolved Universal Terrestrial Radio Access (E-UTRA); Physical Layer Procedures v. 8.2.0”). Frequency-selective CQI reports are normally enabled in the OFDMA system to facilitate FDPS. There is a delay between the instant the channel quality is measured at the terminal (receiver) to the time when it can be utilized by link adaptation at the base station (transmitter)(for example, the link adaptation delay in High Speed Downlink Packet Access is 2 ms (see in this regard 3GPP TR 25.848, “Physical Layer Aspects of UTRA High Speed Downlink Packet Access, v. 4.0.0”, Technical Specification Group Radio Access Network, March, 2001). If the PRB usage pattern is changing rapidly over time, the variations in inter-cell interference can no longer be tracked on the basis of CQI reports. Thus, time-correlation is introduced to stabilize the PRB usage pattern in the network. The benefit of the correlation constraint on system-level performance is illustrated in reference 1. Note that no modification to the CQI definition is required to enable the proposed interference control technique.

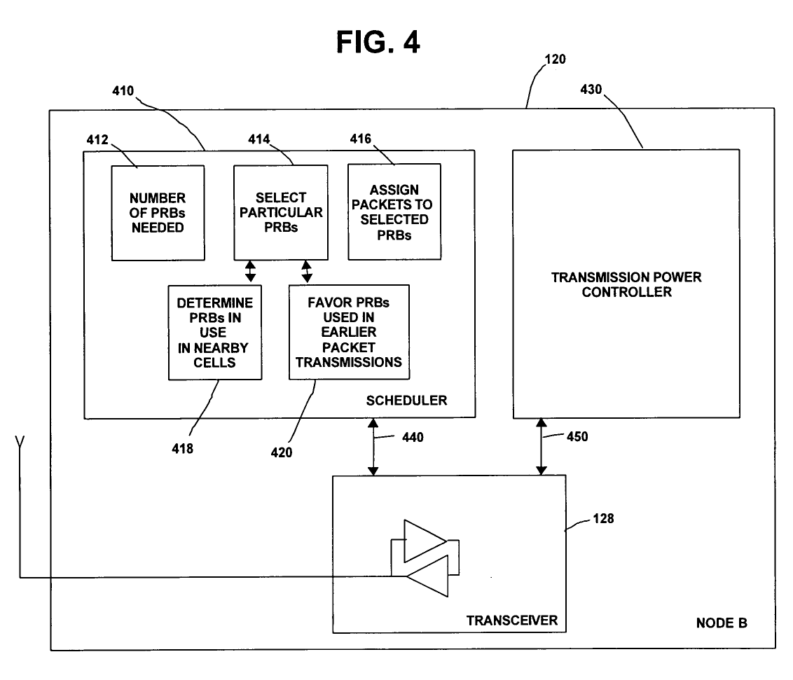

FIG. 4 is a block diagram depicting a base station 120 configured to operate in accordance with the invention. The base station 120 comprises a scheduler block 410; a transmission power control block 430; and a transceiver 128. The scheduler 410 comprises a block 412 for determining the number of PRBs needed in dependence on packet traffic; a block 414 for selecting particular PRBs to be used for packet transmission; and a block 416 for assigning packets to selected PRBs. As can be seen in FIG. 4, block 414 operates in combination with blocks 418, 420. Block 418 determines PRBs likely to be in use in nearby cells using, for example, channel quality information. Block 420 seeks to favor PRBs used in earlier packet transmissions to perform future packet transmissions to increase the time correlation between PRBs used to transmit packets. This significantly eases the task of nearby cells also practicing the invention in seeking to determine the PRBs in use by the cell of interest. Block 430 operates to control the transmission power so that the physical resource blocks selected for packet transmission operations are transmitted at substantially the same power levels. Reference characters 440 and 450 represent signaling and controlling operations occurring between the scheduler 410 and transmission power control 430 and the transceiver 128.

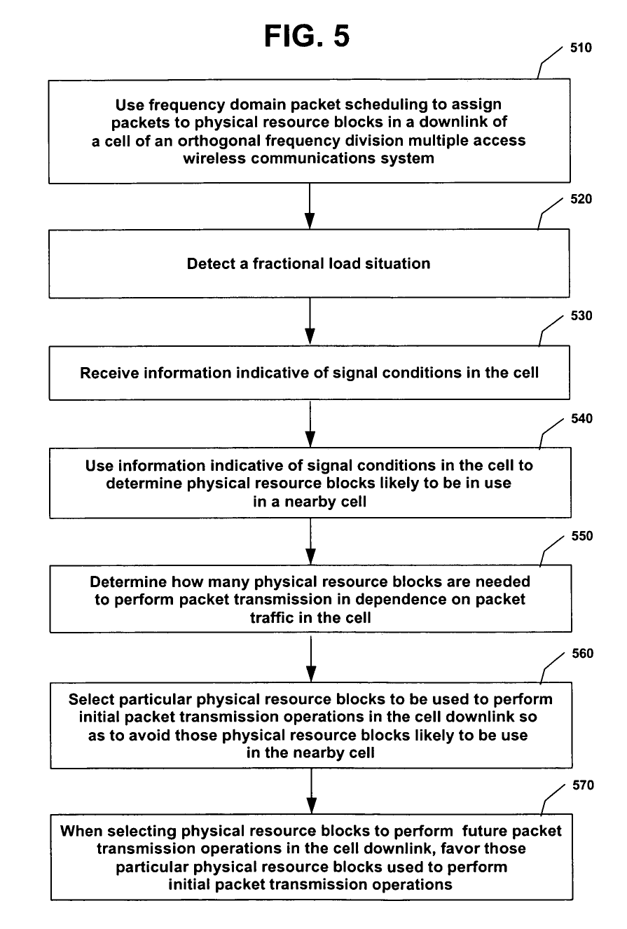

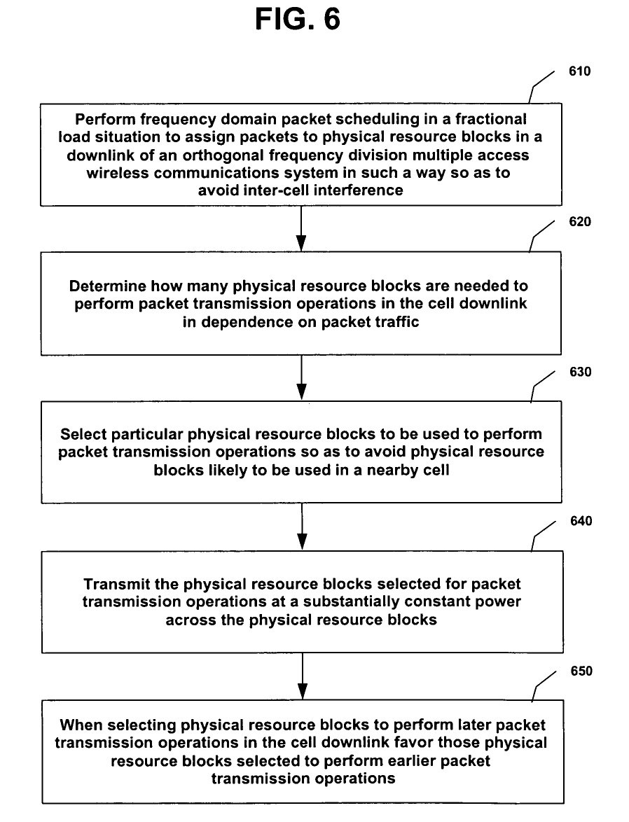

FIGS. 5 and 6 are flowcharts summarizing methods operating in accordance with the invention. As shown at 510 in FIG. 5 apparatus such as, for example, a scheduler operative in a base station generally uses frequency domain packet scheduling to assign packets to physical resource blocks in a downlink of a cell of an orthogonal frequency division multiple access wireless communications system. When a fractional load situation is detected in the communications system at step 520 the scheduler performs the following operations. At 530 the scheduler receives information indicative of signal conditions in the cell. Next, at 540, the scheduler uses the information indicative of signal conditions in the cell to determine physical resource blocks likely to be in use in a nearby cell. Then, at 550, the scheduler determines how many physical resource blocks are needed to perform packet transmission operations in dependence on packet traffic in the cell. Next, at 560, the scheduler selects particular physical resource blocks to be used to perform initial packet transmission operations in the cell downlink so as to avoid those physical resource blocks likely to be in use in the nearby cell. Then, at 570, when selecting physical resource blocks to perform future packet transmission operations in the cell downlink, the scheduler favors those particular physical resource blocks used to perform initial packet transmission operations.

Another method operating in accordance with the invention is depicted in FIG. 6. The method depicted in FIG. 6 may be performed by base station control apparatus comprising a scheduler and a transmission power controller. At step 610, the scheduler performs frequency domain packet scheduling in a fractional load situation, assigning packets to physical resource blocks in a downlink of an orthogonal frequency division multiple access wireless communications system in such a way so as to reduce inter-cell interference. Then, at 620 the scheduler determines how many physical resource blocks are needed to perform packet transmission operations in the cell downlink in dependence on packet traffic. Next, at 630, the scheduler selects particular physical resource blocks to be used to perform packet transmission operations so as to avoid physical resource blocks likely to be used in at least one nearby cell. Then, at 640 the transmission power controller operates the transceiver to transmit the physical resource blocks selected for packet transmission operations at a substantially constant power across the physical resource blocks. Next, at 650, when selecting physical resource blocks to perform later packet transmission operations in the cell downlink the scheduler favors those physical resource blocks selected to perform earlier packet transmission operations.

An embodiment of the invention comprises a scheduler that may be incorporated in a base station operative in a wireless communications network to perform scheduling of packets to be transmitted in a downlink of a cell of the wireless communications network. The scheduling is assumed to occur in a fractional load situation. The scheduler comprises apparatus configured to determine a size of a set of channel components to be used to transmit the packets in the downlink of the wireless communications network in dependence on packet traffic conditions; and to select particular channel components to comprise the set of channel components in such a way so as to favor channel components that have been recently used to perform packet transmission.

As used herein, “channel component” refers to a portion of a channel in a wireless communications system that may be used to carry information. In one exemplary and non-limiting example, a “channel component” comprises a physical resource block in an orthogonal frequency division multiple access (OFDMA) wireless communications system. In OFDMA, users are allocated a specific number of subcarriers for a predetermined amount of time. These are referred to as physical resource blocks (PRBs) in the LTE specifications. PRBs thus have both a time and frequency dimension.

Another embodiment of the invention comprises a scheduler that may be incorporated in a base station operative in a wireless communications network to perform scheduling of packets to be transmitted in a downlink of a cell of the wireless communications network. The scheduling is assumed to occur in a fractional load situation. The scheduler comprises apparatus configured to perform scheduling of packets to be transmitted in downlink of a cell of the wireless communications network, wherein the wireless communications network is an orthogonal frequency division multiple access wireless communications network; to determine a size of a set of physical resource blocks to be used to transmit the packet in dependence on packet traffic conditions; and to select particular physical resource blocks to comprise the set of physical resource blocks in such a way so as to favor physical resource blocks that have been recently used to perform packet transmission.

In a variant of this embodiment, the apparatus is further configured to receive information from which likely physical resource block utilization by adjacent cells of the wireless telecommunications network can be derived.

In another variant of this embodiment, the apparatus is further configured to determine a size of a set of physical resource blocks to be used to transmit packets in dependence also on the derived information reflective of physical resource block utilization by adjacent cells of the wireless telecommunications network.

In a further variant of this embodiment, the apparatus is configured to select physical resource blocks to comprise the set of physical resource blocks in dependence also on the information reflective of physical resource block utilization by adjacent cells so that physical resource blocks likely to be in use by adjacent cells are not selected.

A further embodiment of the invention is method comprising: using frequency domain packet scheduling to assign packets to physical resource blocks in a downlink of a cell of an orthogonal frequency division multiple access wireless communications system; detecting a fractional load situation; receiving information indicative of signal conditions in the cell; using the information indicative of signal conditions in the cell to determine physical resource blocks likely to be in use in a nearby cell; determining how many physical resource blocks are need to perform packet transmission operations in dependence on packet traffic in the cell; select particular physical resource blocks to be used to perform initial packet transmission operations in the cell downlink so as to avoid those physical resource blocks likely to be in use in the nearby cell; and when selecting physical resource blocks to preform future packet transmission operations in the cell downlink, favoring those physical resource blocks used to perform initial packet transmission operations.

Yet another embodiment of the invention is a method comprising: using frequency domain packet scheduling in a fractional load situation to assign packets to physical resource blocks in a cell downlink of an orthogonal frequency division multiple access wireless communications system; determining how many physical resource blocks are need to perform packet transmission operations in the cell downlink in dependence on packet traffic; selecting particular physical resource blocks to be used to perform packet transmission operations so as to avoid physical resource blocks likely to be in use in at least one nearby cell; transmitting the physical resource blocks selected for packet transmission operations at a substantially constant power across the physical resource blocks; and when selecting physical resource blocks to perform later packet transmission operations in the cell downlink, favoring those physical resource blocks selected to perform earlier packet transmission operations.

A still further embodiment of the invention is a base station. The base station comprises: a transceiver configured for bidirectional communications in a wireless telecommunications network; and a base station control apparatus. The base station control apparatus comprises a scheduler and a transmission power controller. The scheduler is configured to perform scheduling of packets to be transmitted in a downlink of a cell of the wireless communications network; to determine a size of a set of physical resource blocks to be used to transmit the packets in dependence on packet traffic conditions; and to select particular physical resource blocks to comprise the set of physical resource blocks in such a way so as to favor physical resource blocks that have been recently used to perform packet transmission. The scheduler is operative in fractional load situations. The transmission power controller is configured to operate the transceiver so as to transmit the physical resource blocks containing the packets at a substantially constant power level across the physical resource blocks.

Another embodiment of the invention is a base station. The base station comprises transceiver means for performing bidirectional communications in a wireless telecommunications network; and a base station control means for controlling operation of the base station. The base station control means further comprises scheduler means and transmission power control means. The scheduler means is for performing scheduling of packets to be transmitted in a downlink of a cell of an orthogonal frequency division multiple access wireless communications system using frequency division packet scheduling; for detecting a fractional load situation; for determining a size of a set of physical resource blocks to be used for transmitting the packets in dependence on packet traffic conditions; and for selecting particular physical resource blocks to comprise the set of physical resource blocks in such a way so as to favor physical resource blocks that have been recently used to perform packet transmission. The transmission power control means is for operating the transceiver means so as to transmit the physical resource blocks containing the packets at a substantially constant power level across the physical resource blocks.

A further embodiment of the invention is a computer program product comprising a computer readable memory medium tangibly embodying a computer program executable by digital processing apparatus. When the computer program is executed by the digital processing apparatus, the computer program causes a base station to perform frequency domain packet scheduling in a fractional load situation by assigning packets to physical resource blocks in a downlink of an orthogonal frequency division multiple access wireless communications system in such a way so as to reduce inter-cell interference; to determine how many physical resource blocks are needed to perform packet transmission operations in the cell downlink in dependence on cell traffic; to select particular physical resource blocks to be used to perform packet transmission operations so as to avoid physical resource blocks likely to be in use in at least one nearby cell; to transmit the physical resource blocks selected for packet transmission operations at substantially constant power across the physical resource blocks; and to select physical resource blocks to perform later packet transmission operations in the cell downlink in such a way so as to favor physical resource blocks selected to perform earlier packet transmission operations.

Yet another embodiment of the invention is a computer program product comprising a computer readable memory medium storing a computer readable program executable by digital processing apparatus. When executed by digital processing apparatus the computer program is configured to cause a base station to perform frequency domain packet scheduling by assigning packets to physical resource blocks in a downlink of a cell of an orthogonal frequency division multiple access wireless communications system; to detect a fractional load situation; to receive information indicative of signal conditions in the cell; to use the information indicative of signal conditions in the cell to determine physical resource blocks likely to be in use in a nearby cell; to determine how many physical resource blocks are needed to perform packet transmission operations in dependence on packet traffic in the cell; to select particular physical resource blocks to be used to perform initial packet transmission operations in the cell downlink so as to avoid those physical resource blocks likely to be in use in the nearby cell; and when selecting physical resource blocks to perform future packet transmission operations in the cell downlink, to favor those particular physical resource blocks that were used to perform initial packet transmission operations.

Thus it is seen that the foregoing description has provided by way of exemplary and non-limiting examples a full and informative description of the best methods and apparatus presently contemplated by the inventors for implementing frequency domain packet scheduling under fractional load. One skilled in the art will appreciate that the various embodiments described herein can be practiced individually; in combination with one or more other embodiments described herein; or in combination with schedulers differing from those described herein. Further, one skilled in the art will appreciate that the present invention can be practiced by other than the described embodiments; that these described embodiments are presented for the purposes of illustration and not of limitation.

What is claimed is:

1. An apparatus comprising a scheduler, the scheduler configured to perform scheduling of packets to be transmitted in a downlink of a cell of a wireless communications network during a fractional load period, the scheduler further configured to determine a size of a set of channel components to be used to transmit the packets in the downlink in dependence on packet traffic conditions; and to select particular channel components to comprise the set of channel components in such a way so as to favor channel components that have been recently used to perform packet transmission.

2. The apparatus of claim 1 wherein the scheduler is further configured to receive information from which channel component utilization by adjacent cells of the wireless telecommunications network can be derived.

3. The apparatus of claim 2 wherein the scheduler is further configured to determine a size of a set of channel components to be used to transmit packets in dependence on the derived information reflective of channel component utilization by adjacent cells of the wireless telecommunications network.

4. The apparatus of claim 3 wherein the scheduler is further configured to select channel components to comprise the set of channel components in dependence on the information reflective of channel component utilization by adjacent cells so that channel components in use by adjacent cells are not selected.

5. The apparatus of claim 1 further comprising a transceiver to transmit the packets in the selected channel components.

6. The apparatus of claim 5 further comprising a transmission power controller configured to control transmission power of the transceiver.

7. The apparatus of claim 6 wherein the transmission power controller is further configured to control the transmission power of the transceiver so that the packets in the selected channel components are transmitted by the transceiver at a substantially constant power level across the selected channel components.

8. The apparatus of claim 1 wherein the wireless communications system is an orthogonal frequency division multiple access wireless communications system; and where the channel components comprise physical resource blocks.

9. The apparatus of claim 8 wherein the scheduler is further configured to receive information from which physical resource block utilization by adjacent cells of the wireless telecommunications network can be derived.

10. The apparatus of claim 9 wherein the scheduler is further configured to determine a size of a set of physical resource blocks to be used to transmit packets in dependence on the derived information reflective of physical resource block utilization by adjacent cells of the wireless telecommunications network.

11. The apparatus of claim 10 wherein the scheduler is further configured to select physical resource blocks to comprise the set of physical resource blocks in dependence on the information reflective of physical resource block utilization by adjacent cells so that physical resource blocks likely to be in use by adjacent cells are not selected.

12. The apparatus of claim 8 further comprising a transceiver to transmit the packets in the selected physical resource blocks.

13. The apparatus of claim 12 further comprising a transmission power controller configured to control transmission power of the transceiver.

14. The apparatus of claim 13 wherein the transmission power controller is further configured to control the transmission power of the transceiver so that the selected physical resource blocks are transmitted at a substantially constant power level across the selected physical resource blocks.

15. A method comprising:
using packet scheduling to assign packets to channel components in a downlink of a cell of a wireless communications system;
detecting a fractional load situation;
determining how many channel components are needed to perform packet transmission operations in dependence on packet traffic in the cell;
selecting particular channel components to be used to perform initial packet transmission operations; and
when selecting channel components to perform future packet transmission operations in the cell downlink, selecting first those channel components used to perform initial packet transmission operations.

16. The method of claim 15 further comprising:
receiving information indicative of signal conditions in the cell;
using the information indicative of signal conditions in the cell to determine channel components in use in a nearby cell; and
when selecting particular channel components to be used to perform initial packet transmission operations in the cell downlink, selecting particular channel components so as to avoid those channel components in use in the nearby cell.

17. The method of claim 16 further comprising transmitting the channel components selected for packet transmission operations at a substantially constant power across the channel components.

18. The method of claim 15 wherein the wireless communications system is an orthogonal frequency division multiple access wireless communications system.

19. The method of claim 18 wherein the channel components further comprise physical resource blocks.

20. A method comprising:
using packet scheduling in a fractional load situation to assign packets to channel components in a cell downlink of a wireless communications system;
determining how many channel components are needed to perform packet transmission operations in the cell downlink in dependence on packet traffic; and
selecting particular channel components to be used to perform packet transmission operations so as to avoid channel components in use in at least one nearby cell.

21. The method of claim 20 further comprising:
transmitting the channel components selected for packet transmission operations at a substantially constant power across the channel components.

22. The method of claim 20 further comprising:
when selecting channel components to perform later packet transmission operations in the cell downlink, selecting first those physical resource blocks selected to perform earlier packet transmission operations.

23. The method of claim 20 wherein the packet scheduling further comprises frequency domain packet scheduling.

24. The method of claim 20 wherein the wireless communications system is an orthogonal frequency division multiple access wireless communications system.

25. The method of claim 24 wherein the channel components further comprise physical resource blocks.

26. An apparatus comprising: a scheduler means for performing scheduling of packets to be transmitted in a downlink of a cell of a wireless communications system during a fractional load period; means for detecting the fractional load period; means for determining a size of a set of channel components to be used for transmitting the packets in dependence on packet traffic conditions; and means for selecting channel components to comprise the set of channel components in such a way so as to favor channel components that have been recently used to perform packet transmission.

27. The apparatus of claim 26 further comprising means for receiving information from which channel component utilization by adjacent cells of the wireless telecommunications network can be derived.

28. The apparatus of claim 27 further comprising means for determining a size of a set of channel components to be used to transmit packets in dependence on the derived information reflective of channel component utilization by adjacent cells of the wireless telecommunications network.

29. The apparatus of claim 28 further comprising means for selecting channel components to comprise the set of channel components in dependence on the information reflective of channel component utilization by adjacent cells so that channel components in use by adjacent cells are not selected.

30. The apparatus of claim 26 further comprising:
transmitter means for transmitting the set of channel components containing the packets; and
transmission power control means for operating the transmitter means so as to transmit the channel components containing the packets at a substantially constant power level across the channel components.

31. The apparatus of claim 26 wherein the wireless communications system comprises an orthogonal frequency division multiple access wireless communications system, and where the channel components comprise physical resource blocks.

32. A computer program product comprising a computer readable memory medium tangibly embodying a computer program executable by a digital processor, wherein when the computer program is executed by the digital processor, the computer program is configured to cause an apparatus operative in a wireless communications system to perform packet scheduling in a fractional load situation by assigning packets to channel components in a downlink of the wireless communications system in such a way so as to reduce inter-cell interference; to determine a size of a set of channel components needed to perform packet transmission operations in the cell downlink in dependence on cell traffic; and to select particular channel components to be used to perform packet transmission operations so as to avoid channel components in use in at least one nearby cell.

33. The computer program product of claim 32 wherein when the computer program is executed by the digital processor, the computer program is further configured to operate the apparatus to transmit the channel components selected for packet transmission operations at substantially constant power across the channel components.

34. The computer program product of claim 32 wherein when the computer program is executed by the digital processor, the computer program is further configured to operate the apparatus to select channel components to perform later packet transmission operations in the cell downlink in such a way so as to favor channel components selected to perform earlier packet transmission operations.

35. The computer program product of claim 32 wherein the computer program, when executed, is further configured to operate the apparatus to receive information from which channel component utilization by adjacent cells of the wireless telecommunications network can be derived.

36. The computer program product 35 wherein the computer program, when executed, is further configured to operate the apparatus to determine a size of a set of channel components to be used to transmit packets in dependence on the derived information reflective of channel component utilization by adjacent cells of the wireless telecommunications network.

37. The computer program product of claim 32 wherein the wireless communications system further comprises an orthogonal frequency division multiple access wireless communications system.

38. The computer program product of claim 37 wherein the channel components comprise physical resource blocks.

39. A computer program product comprising a computer readable memory medium storing a computer readable program executable by a digital processor, wherein when executed by the digital processor the computer program is configured to operate apparatus to perform packet scheduling by assigning packets to channel components in a downlink of the wireless communications system; to detect a fractional load situation; to receive information indicative of signal conditions in the cell; to use the information indicative of signal conditions in the cell to determine channel components likely to be in use in a nearby cell; to determine how many channel components are needed to perform packet transmission operations in dependence on packet traffic in the cell; and to select particular channel components to be used to perform initial packet transmission operations in the cell downlink so as to avoid those channel components likely to be in use in the nearby cell.

40. The computer program product of claim 39 wherein the computer program, when executed, is further configured to operate the apparatus to select channel components to perform future packet transmission operations in the cell downlink; and when selecting channel components to perform future packer transmission operations, to favor those channel components that were used to perform initial packet transmission operations.

41. The computer program product of claim 39 wherein the wireless communications system further comprises an orthogonal frequency division multiple access wireless communications system.

42. The computer program product of claim 41 wherein the channel components comprise physical resource blocks.
